(19) United States
(12) Patent Application Publication
(10) Pub. No.: US 2001/0048767 A1
(43) Pub. Date: Dec. 6, 2001

(54) Indexing method of feature vector data space

(76) Inventors: Hyun-doo Shin, Seongnam-city (KR); Yang-lim Choi, Suwon-city (KR); Bangalore S. Manjunath, Santa Barbara, CA (US); Peng Wu, Santa Barbara, CA (US)

Correspondence Address: SUGHRUE, MION, ZINN,, MACPEAK & SEAS, PLLC, 2100 PENNSYLVANIA AVENUE, N.W., WASHINGTON, DC, 20037-3213, US

(21) Appl. No.: 09/823,272

(22) Filed: Apr. 2, 2001

Related U.S. Application Data
(60) Provisional application No. 60/208,086, filed on May 31, 2000.

(30) Foreign Application Priority Data
Aug. 21, 2000 (KR) 00-48323
Mar. 29, 2001 (EP) 01302946.7
Mar. 28, 2001 (CN) 01112111.4
Mar. 21, 2001 (JP) 2001-81532

(51) Int. Cl. G06K 9/00

(52) U.S. Cl. 382/209; 382/170

(57) ABSTRACT

An indexing method of a feature vector data space, which can be used for a similarity search in a multidimensional vector space, is provided. The indexing method includes the steps of (a) determining whether at least one cell, on which feature vectors are concentrated, exists, and (b) hierarchically indexing the feature vector data space when it is determined that at least one cell, on which feature vectors are concentrated, exists in the step (a). Accordingly, the feature vector data space can be finely indexed when feature vectors are not uniformly distributed in a high-dimensional vector space.

### BACKGROUND OF THE INVENTION

1. Field of the Invention

The present invention relates to an indexing method of a feature vector data space, and more particularly, to an indexing method for finely indexing cells having a high concentration of feature vectors by hierarchically approximating the feature vectors depending on their distribution in a feature vector data space. The present application claims benefit of priority under 35 U.S.C. § 119(e) of U.S. Provisional Application No. 60/208,086, filed May 31, 2000, which is incorporated herein by reference. The present application is also based on Korean Patent Application No. 2000-48323, filed Aug. 21, 2000, which is also incorporated herein by reference.

2. Description of the Related Art

Fast and efficient access to a database is always of concern when dealing with large quantities of multimedia data. Nowadays, with the rapidly growing ability to produce multimedia data, managing such databases and providing methods to access the multimedia content has become an important issue. For example, typical image collection may range from a few hundred thousand to a few million or more items. For each object (or record) in the database, its degree (the dimensionality of the attributes) is much higher than that of a conventional database.

To access a database with such properties, an efficient indexing method has to be carefully designed. The efficiency of an indexing method can be evaluated fairly by focusing on the indexing method. For example, some indexing methods aim at minimizing storage overhead; while others may focus on efficiently supporting the range of queries.

Indexing multidimensional data has been a research issue for years. But for multimedia databases, due to their domain specific needs, there has not been a satisfactory data structure to support the nearest neighbor (NN)-search efficiently.

To solve this problem, a conventional indexing method uses a vector approximation (VA)-file. However, such a conventional indexing method may be affected by the distribution of feature vectors. According to this conventional indexing method, it is reasonable to expect a great reduction of complexity when the feature vectors are uniformly distributed. However, efficient indexing may not be accomplished when the feature vectors are not uniformly distributed.

### SUMMARY OF THE INVENTION

To solve the above problems, it is a first object of the present invention to provide an indexing method of a feature vector data space, by which cells having a high concentration of feature vectors can be finely indexed.

It is a second object of the present invention to provide a computer-readable recording medium for storing program codes used for performing the indexing method of a feature vector data space.

It is a third object of the present invention to provide a similarity searching method of performing a similarity search in a feature vector data space where the indexing method of a feature vector data space has been performed.

Accordingly, to achieve the first object of the invention, there is provided an indexing method of a feature vector data space. The method includes the steps of (a) determining whether at least one cell, on which feature vectors are concentrated, exists and (b) hierarchically indexing the feature vector data space when it is determined that at least one cell, on which feature vectors are concentrated, exists in the step (a).

The indexing method also preferably includes the step of (pa-1) partitioning the feature vector data space into a plurality of cells having a uniform size, before the step (a).

The step (a) preferably includes the steps of (a-1) constructing a histogram illustrating the number of feature vectors in each cell, and (a-2) analyzing the distribution of the feature vectors using the histogram and determining whether at least one cell, on which feature vectors are concentrated, exists.

Preferably, the step (b) includes the step of indexing the feature vector data space using a vector approximation file.

The step (b) includes the steps of (b-1) constructing a sub-vector approximation file over each cell on which feature vectors are concentrated, and (b-2) approximating feature vectors in each cell, on which feature vectors are concentrated, using the vector approximation file and a corresponding subvector approximation file.

The step (b) includes the steps of (b-1) partitioning corresponding cells into sub-cells when it is determined that at least one cell, on which feature vectors are concentrated, exists in the step (a), and (b-2) approximating the feature vectors in each of the corresponding cells using the sub-cells, thereby hierarchically indexing the feature vector data space.

To achieve the second object of the invention, there is provided a computer-readable recording medium for storing program codes used for performing an indexing method of a feature vector data space. The indexing method includes the steps of (a) determining whether at least one cell, on which feature vectors are concentrated, exists, and (b) hierarchically indexing the feature vector data space, when it is determined that at least one cell on which feature vectors are concentrated, exists in the step (a).

To achieve the third object of the invention, there is provided a method of searching for similarity, including the step of performing a similarity search in the feature vector data space which has been indexed, by determining whether cells, on which feature vectors are concentrated, exist and hierarchically indexing feature vectors in the cells on which it is determined that feature vectors are concentrated, according to a predetermined indexing method.

### BRIEF DESCRIPTION OF THE DRAWINGS

The above objectives and advantages of the present invention will become more apparent by describing in detail a preferred embodiment thereof with reference to the attached drawings in which:

FIG. 1 is a flowchart illustrating an indexing method of a feature vector data space according to an embodiment of the present invention;

FIG. 2 is a diagram illustrating an example of a feature vector data space over which a vector approximation (VA)-file is constructed; and

FIGS. 3A and 3B are diagrams illustrating examples in which a cell defined as an attractor is partitioned into a plurality of sub-cells.

### DETAILED DESCRIPTION OF THE PRESENT INVENTION

Hereinafter, embodiments of the present invention will be described in detail with reference to the attached drawings.

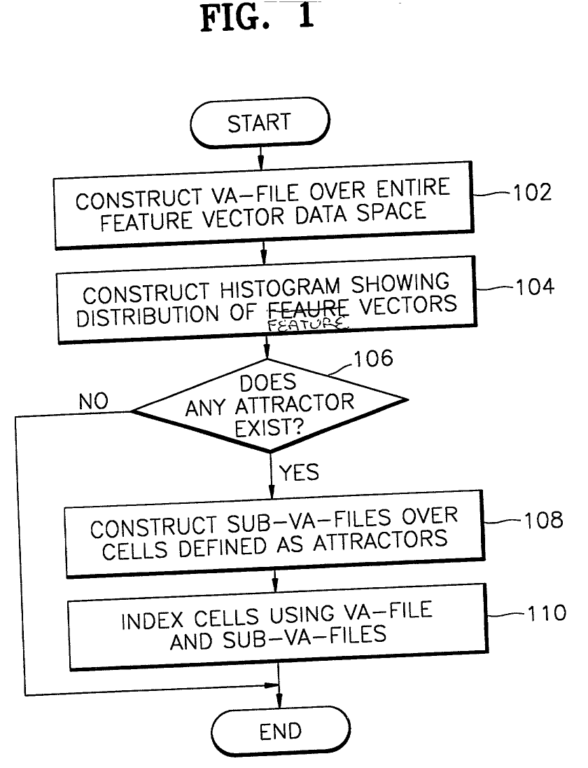

Referring to FIG. 1, in an indexing method, according to an embodiment of the present invention, a vector approximation (VA)-file is constructed over an entire feature vector data space in step 102. To construct the VA-file, the feature vector data space is partitioned into a plurality of cells having a uniform size. In this specification, to explain a situation where the present invention works effectively, it is assumed that feature vectors are concentrated on some arbitrary cells among the plurality of partitioned cells.

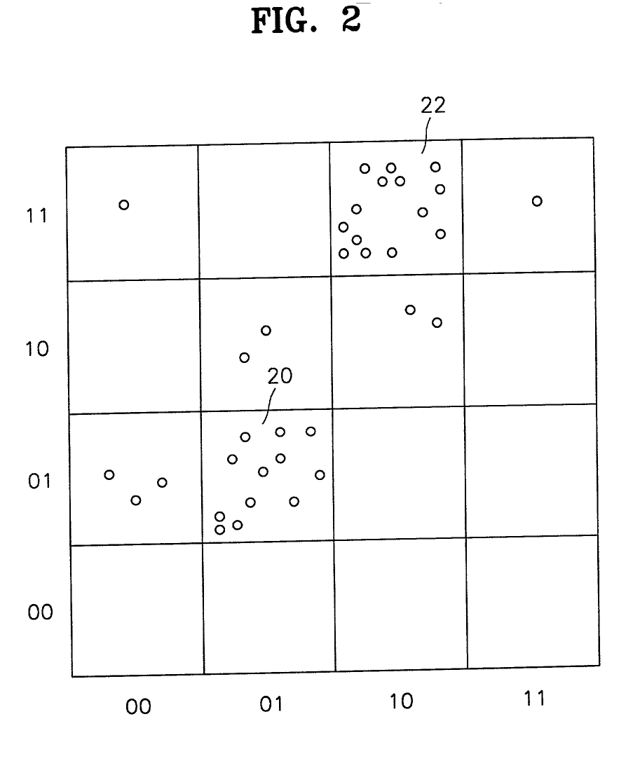

FIG. 2 shows an example of a feature vector data space over which a VA-file is constructed. Referring to FIG. 2, feature vectors are concentrated on a cell 20 in which feature vectors approximate to 01 01 and on a cell 22 in which feature vectors approximate to 10 11. Hereinafter, a cell on which feature vectors are concentrated is referred to as an attractor.

Next, in step 104, a histogram illustrating the distribution of feature vectors throughout the entire feature vector data space is obtained. In step 106, it is determined based on the histogram whether any attractor exists. For example, from the histogram, it is possible to define a cell having at least a predetermined number of feature vectors as an attractor. In this embodiment, a cell having 10 or more feature vectors is defined as an attractor. For example, it appears that the cells 20 and 22 in FIG. 2 have more than 10 feature vectors, so the cells 20 and 22 are defined as attractors.

In step 108, a sub-VA-file is constructed over a cell defined as an attractor when the existence of an attractor is confirmed. The cell defined as an attractor is partitioned into a plurality of sub-cells. The sub-VA-file is constructed based on the locations of feature vectors in the sub-cell.

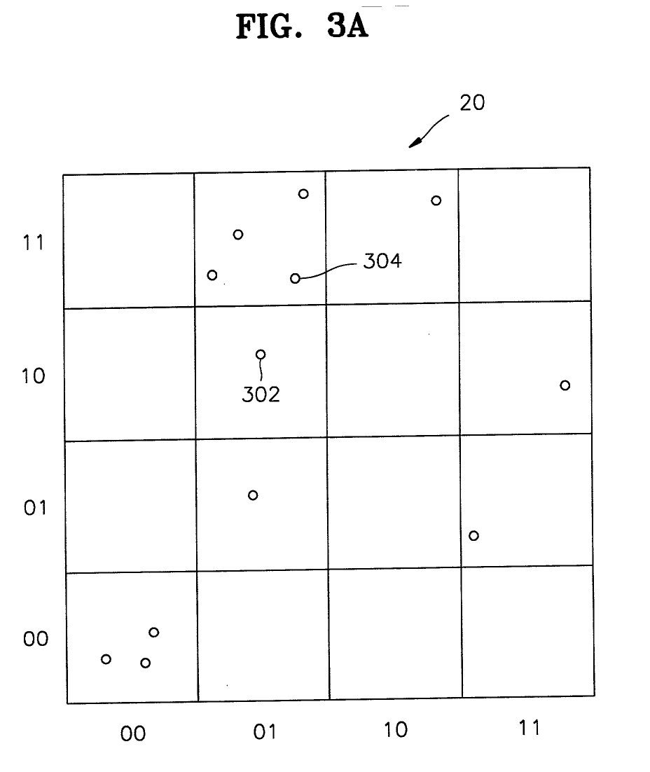

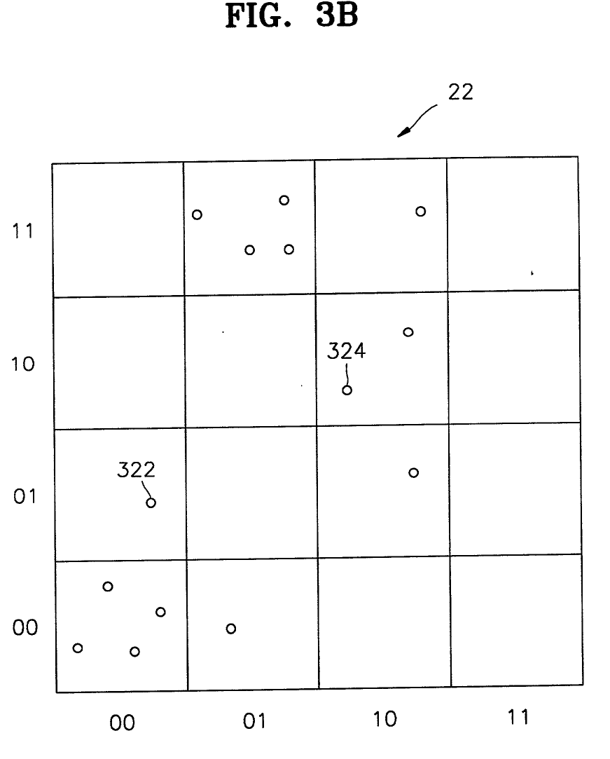

FIGS. 3A and 3B are diagrams illustrating examples in which a cell defined as an attractor is partitioned into a plurality of sub-cells. In FIG. 3A, the cell 20 of 01 01 in FIG. 2 is partitioned into a plurality of sub-cells. In FIG. 3B, the cell 22 of 10 11 in FIG. 2 is partitioned into a plurality of sub-cells. A sub-VA-file is constructed based on the locations of feature vectors in a sub-cell.

On the other hand, if no attractors exist, which means the uniformity of the vector space can be at least approximately maintained, a typical VA-file will be used. In other words, a VA-file is constructed by approximating the feature vectors in the feature vector data space in partitioned cell units.

In step 110, feature vectors in the cell defined as an attractor are approximated using the VA-file and the sub-VA-file. For example, feature vector data 302 and feature vector data 304 in the cell 20 of 01 01 in FIG. 2 are approximated as 01 01 01 10 and 01 01 01 11, respectively. Feature vector data 322 and feature vector data 324 in the cell 22 of 10 11 in FIG. 2 are approximated as 10 11 00 01 and 10 11 10 10, respectively. Therefore, the cell is indexed based on a file in which the VA-file and the sub-VA-file are united. The file in which the VA-file and the sub-VA-file are united may be referred to as a hierarchical vector approximation (HVA)-file.

According to an indexing method of the present invention, a feature vector data space is hierarchically approximated, based on the distribution of feature vectors, in order to index cells. Hierarchical indexing allows cells having a high concentration of feature vectors to be finely indexed. In particular, according to the present invention, more efficient indexing of feature vectors can be achieved when the feature vectors are not uniformly distributed in a high-dimensional vector space. In other words, an approximation structure is adjusted depending on the distribution of feature vector data in a feature vector data space to cope with the concentration of feature vector data.

A method of performing a similarity search on a feature vector data space which has been hierarchically indexed according to the indexing method of a feature vector space described with reference to FIG. 1, will be described. Feature vectors in each cell on which feature vectors are concentrated in the feature vector data space, have been approximated using a sub-VA-file. For example, when a similarity search is performed on a query point approximated as 01, 01, 10, 10, a cell with coordinates 01, 01 in the feature vector data space is selected as a searched cell, and it is determined whether a cell approximated as 10, 10 exists in the selected cell. When it is determined that the cell approximated as 10, 10 exists in the selected cell, the selected cell is determined as a searched cell.

Such a similarity searching method allows a feature point having a similar feature to a query point to be finely and accurately searched in a feature vector data space even if feature vectors are not uniformly distributed in the high-dimensional vector space. For a searching method, a variety of searching methods including nearest neighbor (NN) searching may be used.

In the embodiment described with reference to FIG. 1, 2-step hierarchical indexing is performed, but hierarchical indexing with more steps may be performed. In the embodiment described with reference to FIG. 1, a histogram is used to determine whether an attractor exists, but modifications or changes to the analyzing method can be made by those skilled in the art. In other words, the scope of the present invention defined by the attached claims is not restricted to the above embodiment.

An indexing method according to the present invention can be made into programs which can be executed on a personal computer or a server computer. Program codes and code segments constructing the programs can be easily inferred by computer programmers skilled in the art. The programs can be stored in a computer-readable recording medium. The computer-readable medium could be a magnetic recording medium, an optical recording medium or a carrier wave.

As described above, in an indexing method of a feature vector data space, according to the present invention, the feature vector data space can be finely indexed when feature vectors are not uniformly distributed in a high-dimensional vector space.

In addition, a similarity searching method according to the present invention allows a feature point having a similar feature to a query point, to be finely and accurately searched for in a feature vector data space, even if feature vectors are not uniformly distributed in the high-dimensional vector space.

What is claimed is:

1. An indexing method of a feature vector data space in which a plurality of feature vectors are indexed, the indexing method comprising the steps of:
(a) determining whether one or more cells, on each of which one or more of said plurality of feature vectors are correspondingly concentrated, exist; and
(b) hierarchically indexing the feature vector data space when it is determined that said one or more cells, on each of which said one or more of said plurality of feature vectors are correspondingly concentrated, exist in the step (a).

2. The indexing method of claim 1, further comprising a step of (pa-1) partitioning the feature vector data space into a plurality of cells, including said one or more cells, having a uniform size, before the step (a).

3. The indexing method of claim 1, wherein the step (a) comprises the sub-steps of:
(a-1) constructing a histogram illustrating a number of said plurality of feature vectors in each of a plurality of cells, including said one or more cells; and
(a-2) analyzing a distribution of said plurality of feature vectors using the histogram and determining whether said one or more cells, on each of which said one or more of said plurality of feature vectors are correspondingly concentrated, exist.

4. The indexing method of claim 1, wherein the step (b) comprises the step of indexing the feature vector data space using a vector approximation file.

5. The indexing method of claim 4, wherein the step (b) comprises the sub-steps of:
(b-1) constructing a sub-vector approximation file over each of said one or more cells, on which said one or more of said plurality of feature vectors are correspondingly concentrated; and
(b-2) approximating said one or more of said plurality of feature vectors in said each of said one or more cells, on which said one or more of said plurality of feature vectors are correspondingly concentrated, using the vector approximation file and a corresponding sub-vector approximation file.

6. The indexing method of claim 1, wherein the step (b) comprises the sub-steps of:
(b-1) partitioning each of said one or more cells into a corresponding plurality of sub-cells, when it is determined that said each of said one or more cells, on which said one or more of said plurality of feature vectors are correspondingly concentrated, exists in the step (a); and
(b-2) approximating said one or more of said plurality of feature vectors in said each of said one or more cells, using said corresponding plurality of sub-cells, thereby hierarchically indexing the feature vector data space.

7. A computer-readable recording medium for storing program codes for performing an indexing method of a feature vector data space in which a plurality of feature vectors are indexed, the indexing method comprising the steps of:
(a) determining whether one or more cells, on each of which one or more of said plurality of feature vectors are correspondingly concentrated, exist; and
(b) hierarchically indexing the feature vector data space when it is determined that said one or more cells, on each of which said one or more of said plurality of feature vectors are correspondingly concentrated, exist in the step (a).

8. The computer-readable recording medium of claim 7, wherein the step (b) comprises the step of indexing the feature vector data space using a vector approximation file.

9. The computer-readable recording medium of claim 7, further comprising a step of (pa-1) partitioning the feature vector data space into a plurality of cells, including said one or more cells, having a uniform size, before the step (a).

10. The computer-readable recording medium of claim 7, wherein the step (b) comprises the sub-steps of:
(b-1) partitioning each of said one or more cells into a corresponding plurality of sub-cells, when it is determined that said each of said one or more cells, on which said one or more of said plurality of feature vectors are correspondingly concentrated, exists in the step (a); and
(b-2) approximating said one or more of said plurality of feature vectors in said each of said one or more cells, using said corresponding plurality of sub-cells, thereby hierarchically indexing the feature vector data space.

11. The computer-readable recording medium of claim 8, wherein the step (a) comprises the sub-steps of:
(a-1) constructing a histogram illustrating a number of said plurality of feature vectors in each of a plurality of cells, including said one or more cells; and
(a-2) analyzing a distribution of said plurality of feature vectors using the histogram and determining whether said one or more cells, on each of which said one or more of said plurality of feature vectors are correspondingly concentrated, exist, and
the step (b) comprises the sub-steps of:
(b-1) constructing a sub-vector approximation file over each of said one or more cells, on which said one or more of said plurality of feature vectors are correspondingly concentrated; and
(b-2) approximating said one or more of said plurality of feature vectors in said each of said one or more cells, on which said one or more of said plurality of feature vectors are correspondingly concentrated, using the vector approximation file and a corresponding sub-vector approximation file.

12. A method of searching for similarity in a feature vector data space in which feature vectors are indexed, the method comprising the step of (a) performing a similarity search in the feature vector data space, which has been indexed, by determining whether each of one or more cells, on which the feature vectors are correspondingly concentrated, exists and hierarchically indexing the feature vectors in said each of one or more cells, on which it is determined that the feature vectors are correspondingly concentrated, according to a predetermined indexing method.

13. The method of claim 12, wherein the step (a) is performed based on a nearest neighbor search.
